(19) United States
(12) Patent Application Publication
(10) Pub. No.: US 2009/0008449 A1
(43) Pub. Date: Jan. 8, 2009

(54) Multi-Loop Antenna for Radio Frequency Identification Applications

(75) Inventors: Xianming Qing, Singapore (SG); Zhining Chen, Singapore (SG); Ailian Cai, Singapore (SG)

Correspondence Address: CONLEY ROSE, P.C.;David A. Rose, P. O. BOX 3267, HOUSTON, TX, 77253-3267, US

(73) Assignee: AGENCY FOR SCIENCE, TECHNOLOGY AND RESEARCH, Singapore (SG)

(21) Appl. No.: 12/094,039

(22) PCT Filed: Aug. 15, 2006
(86) PCT No.: PCT/SG2006/000231

§ 371 Date: Sep. 4, 2008

(30) Foreign Application Priority Data
Nov. 19, 2005 (SG) PCT/SG2005/000396

(51) Int. Cl. H01Q 21/00; H01Q 1/50; G06K 7/01

(52) U.S. Cl. 235/439; 343/867; 343/860

(57) ABSTRACT

An antenna for radio frequency identification is disclosed. The antenna comprises a first radiating element having at least one loop element and a second radiating element spatially displaced from the first radiating element and having at least two interconnected loop elements. The antenna further comprises a coupler for electrically coupling the first and second radiating elements. Specifically, when a first current flows in the first radiating element for generating a first magnetic field and a second current flows in the second radiating element for generating a second magnetic field, one of the first and second magnetic fields superimposes the other of the first and second magnetic fields for generating an interrogation region in the near field of the first and second radiating elements.

### FIELD OF INVENTION

The invention relates generally to antennas. In particular, it relates to an antenna for radio frequency identification applications.

### BACKGROUND

Radio frequency (RF) communication technology is widely used in modern communication systems. One example is a radio frequency identification (RFID) system. In an RFID system, RFID reader antennas are used to transmit and receive RF signals to and from, respectively, RFID tags. Information stored in the RFID tags is usually editable and therefore updateable. The RFID system is therefore commonly used in logistical applications, such as in a warehouse for managing inventory flow.

Near field RFID systems normally use loop antennas for coupling RF signals. However, existing loop antennas have limited coverage for effective communication with the RFID tags due to the orientation of the RFID tags.

Furthermore, many of the loop antennas have complicated structures that are undesirably difficult and costly to fabricate. High fabrication cost is incurred when a large number of the loop antennas are needed to provide the required coverage.

There is therefore a need for an antenna for an RFID system for increasing coverage and improving cost efficiency.

### SUMMARY

Embodiments of the invention are disclosed hereinafter for RFID applications that increase coverage and improve cost efficiency.

In accordance with an embodiment of the invention, there is disclosed an antenna for radio frequency identification. The antenna comprises a first radiating element having at least one loop element and a second radiating element spatially displaced from the first radiating element and having at least two interconnected loop elements. The antenna further comprises a coupler for electrically coupling the first and second radiating elements. Specifically, when a first current flows in the first radiating element for generating a first magnetic field and a second current flows in the second radiating element for generating a second magnetic field, one of the first and second magnetic fields superimposes the other of the first and second magnetic fields for generating an interrogation region in the near field of the first and second radiating elements.

In accordance with another embodiment of the invention, there is disclosed a method for configuring an antenna for radio frequency identification. The method involves the step of providing a first radiating element having at least one loop element and the step of providing a second radiating element spatially displaced from the first radiating element and having at least two interconnected loop elements. The method further involves the step of providing a coupler for electrically coupling the first and second radiating elements. Specifically, when a first current flows in the first radiating element for generating a first magnetic field and a second current flows in the second radiating element for generating a second magnetic field, one of the first and second magnetic fields superimposes the other of the first and second magnetic fields for generating an interrogation region in the near field of the first and second radiating elements.

In accordance with yet another embodiment of the invention, there is disclosed a system for configuring an antenna for radio frequency identification applications. The system has a host for sending and receiving data. The system also includes a gateway that is coupled to the host for controlling the data sent to and from the host, and an RFID reader that is coupled to the gateway for reading radio frequency signals. The system further contains at least one antenna for transmitting and receiving radio frequency signals, each of the at least one antenna having a first radiating element and a second radiating element, and an antenna multiplexer that is coupled to the gateway and the RFID reader for selecting the at least one antenna for reading data, wherein when a first current flows in the first radiating element for generating a first magnetic field and a second current flows in the second radiating element for generating a second magnetic field, one of the first and second magnetic fields superimposes the other of the first and second magnetic fields for generating an interrogation region in the near field of the first and second radiating elements.

### BRIEF DESCRIPTION OF DRAWINGS

Embodiments of the invention are described in detail hereinafter with reference to the drawings, in which:

FIG. 1a is a schematic diagram of an antenna having two radiating elements interconnected at a first pair of loops, according to a first embodiment of the invention;

FIG. 1b is a cross-sectional view of the antenna of FIG. 1a;

FIG. 2 is a schematic diagram showing the antenna of FIG. 1 interconnected at a second pair of loops;

FIG. 3 is a plan view of one of the two radiation elements of the antenna of FIG. 1;

FIG. 4 illustrates the operational principles of the radiating element of FIG. 3;

FIG. 5 is a graph showing the magnetic field distribution of the antenna of FIG. 1;

FIG. 6 is a graph showing the measured returned loss of the antenna of FIG. 1;

FIG. 7 illustrates exemplary geometrical shapes of the loops of the antenna of FIG. 1;

FIG. 8 is a schematic diagram showing two shaped segments of the antenna of FIG. 1 formed on the same side of a substrate;

FIGS. 9a and 9b are exemplary configurations of the loops of the antenna of FIG. 1;

FIGS. 10 to 13 are exemplary implementations of the antenna of FIG. 1; and

FIG. 14 is a block diagram of a system for RFID applications.

### DETAILED DESCRIPTION

With reference to the drawings, an antenna for a radio frequency identification (RFID) system according to embodiments of the invention is disclosed for increasing coverage and improving cost efficiency.

For purposes of brevity and clarity, the description of the invention is limited hereinafter to near field RFID applications. This however does not preclude various embodiments of the invention from other applications that require similar operating performance as the near field RFID applications. The operational and functional principles fundamental to the embodiments of the invention are common throughout the various embodiments.

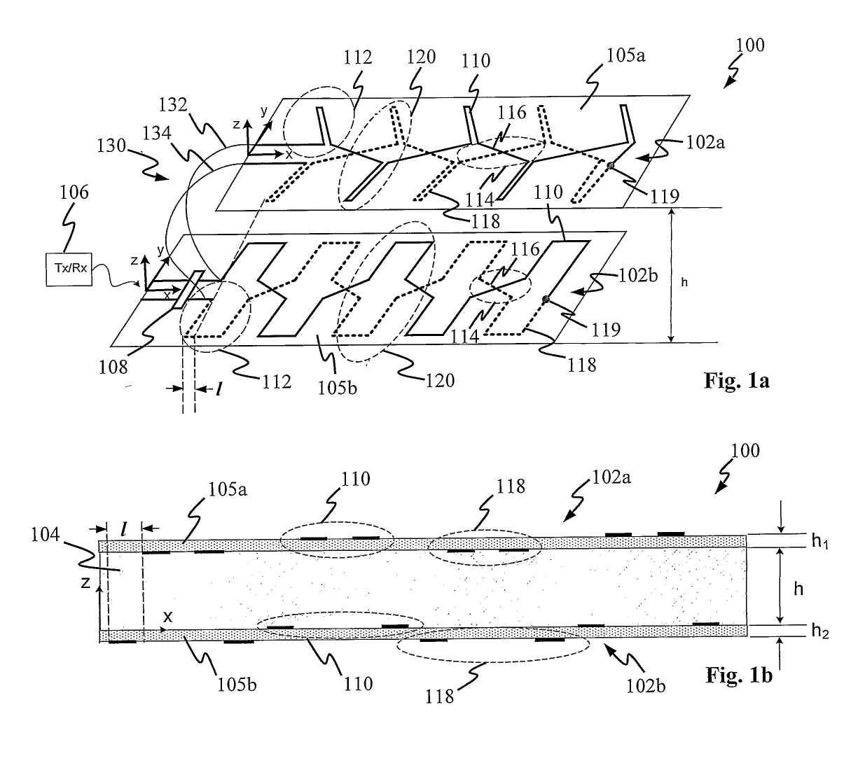

In the detailed description provided hereinafter and illustrations provided in FIGS. 1 to 14 of the drawings, like elements are identified with like reference numerals.

Embodiments of the invention are described in greater detail hereinafter for an antenna for an RFID system for RFID applications.

With reference to FIG. 1a, an antenna 100 according to an embodiment of the invention has a first radiating element 102a and a second radiating element 102b. The first and second radiating elements 102a, 102b are preferably parallel to each other and spaced apart. The first and second radiating elements 102a, 102b are used for transmitting powering up signals to RFID tags and receiving RFID signals transmitted by the RFID tags.

The first and second radiating elements 102a, 102b are preferably spatially displaced by a predetermined separation h. A supporting substrate 104 (shown in FIG. 1b) is preferably used for spatially displacing the first and second radiating elements 102a, 102b and for providing the predetermined separation h between the first and second radiating elements 102a, 102b. The amount of separation h is dependable on the configuration of each of the first and second radiating elements 102a, 102b.

The supporting substrate 104 is preferably planar and has a longitudinal span. The supporting substrate 104 is preferably made of non-conductive material such as foam, paper or wood. Alternatively, the first and second radiating elements 102a, 102b may be separated by free space.

A feed 106 is connectable to the radiating elements 102a, 102b for providing the powering up and RFID signals to and from the radiating elements 102a, 102b respectively. An impedance matching network 108 is connected between the radiating elements 102a, 102b and the feed 106 for matching the impedance between the radiating elements 102a, 102b and the feed 106.

The following description of the antenna 100 is made with reference to an x-axis, a y-axis and a z-axis. The three axes are perpendicular to each other. The x and y axes extend along the supporting substrate 104 and are coincident therewith. In particular, the x-axis extends centrally along the longitudinal span of the supporting substrate 104 and is coincident with the centerlines of the first and second radiating elements 102a, 102b.

Each of the first and second radiating elements 102a, 102b preferably comprises a first shaped segment 110 and a second shaped segment 118. The first shaped segment 110 is preferably continuous and wave shaped. The first shaped segment 110 comprises a plurality of lobed portions 112 alternating about the x-axis.

The lobed portions 112 preferably have a geometrical shape such as a polygon or semi-circle and are preferably arranged substantially longitudinally along the x-axis. Each of the lobed portions 112 preferably extends along the y-axis and away from the x-axis and terminates at two ends thereof. Each of the lobed portions 112 is preferably connected at a junction 114 where one or both ends of the lobed portions 112 are connected to an adjacent lobed portion 112 through a connector 116.

The second shaped segment 118 is preferably spaced apart from the first shaped segment 110. The second shaped segment 118 preferably has lobed portions 112 and connectors 116 that are substantially similar in shape and size as the first shaped segment 110 in order to achieve symmetry between the two segments. Although the second shaped segment 118 is substantially a duplicate of the first shaped segment 110, the second shaped segment 118 is preferably flipped about the x-axis and therefore mirrored with respect to the first shaped segment 110. In this way, the lobed portions of both the first and second shaped segments 110, 118 are positioned longitudinally along the x-axis. In particular, each lobed portion 112 of the first shaped segment 110 substantially directly opposes a corresponding mirrored lobed portion 112 of the second shaped segment 118 to consequently define a loop 120.

Alternatively, the lobed portions 112 of the first and second shaped segments 110, 118 have other geometrical shapes, such as a rectangle.

Each loop 120 of the first radiating element 102a preferably has a different geometrical shape to a corresponding overlapping loop 120 of the second radiating element 102b. In addition, each loop 120 of the first radiating element 102a preferably has substantially the same inter-loop spacing as the corresponding overlapping loop 120 of the second radiating element 102b. This means that the center-to-center spacing of adjacent loops 120 is constant and substantially the same for both the first and second radiating elements 102a, 102b.

Each loop 120 of the first radiating element 102a is also preferably laterally displaced with respect to the corresponding loop 120 of the second radiating element 102b by a predetermined lateral displacement l. The lateral displacement l is preferably along the x-axis. In particular, each lobed portion 112 of the first radiating element 102a is preferably laterally displaced along the x-axis and with respect to a corresponding lobed portion 112 of the second radiating element 102b by a predetermined lateral displacement l.

As illustrated in FIG. 1b, the first and second shaped segments 110, 118 of the first radiating element 102a are preferably formed on opposite sides of a first substrate 105a that has a thickness of h₁. Similarly, the first and second shaped segments 110, 118 of the second radiating element 102b are preferably formed on opposite sides of a second substrate 105b that has a thickness of h₂. The first and second shaped segments 110, 118 of each of the first and second radiating elements 102a, 102b are therefore spatially separated except at a connecting point 119. The connection of the first and second shaped segments 110, 118 is preferably achieved by forming conductive vias at the connecting point 119 so that the two segments 110, 118 are electrically coupled.

The first radiating element 102a is preferably a continuous copper track that is laid on the opposite sides of the first substrate 105a while the second radiating element 102b is preferably also a continuous copper track that is laid on the opposite sides of the second substrate 105b. The first and second substrates 105a, 105b are preferably printed circuit boards (PCBs) or are made of non-conductive materials such as foam, paper and wood.

A coupler 130 is preferably used for interconnecting the first and second radiating elements 102a, 102b. The coupler 130 preferably comprises a first connecting wire 132 and a second connecting wire 134. The first connecting wire 132 preferably connects the first shaped segment 110 of the first radiating element 102a to the first shaped segment 110 of the second radiating element 102b. The second connecting wire 134 preferably connects the second shaped segment 118 of the first radiating element 102a to the second shaped segment 118 of the second radiating element 102b. The first and second radiating elements 102a, 102b are preferably connected through the coupler to the impedance matching network 108 and further connected to the feed 106. In particular, each of the first and second shaped segments 110, 118 of the second radiating element 102b is connected to a terminal of the impedance matching network. 108.

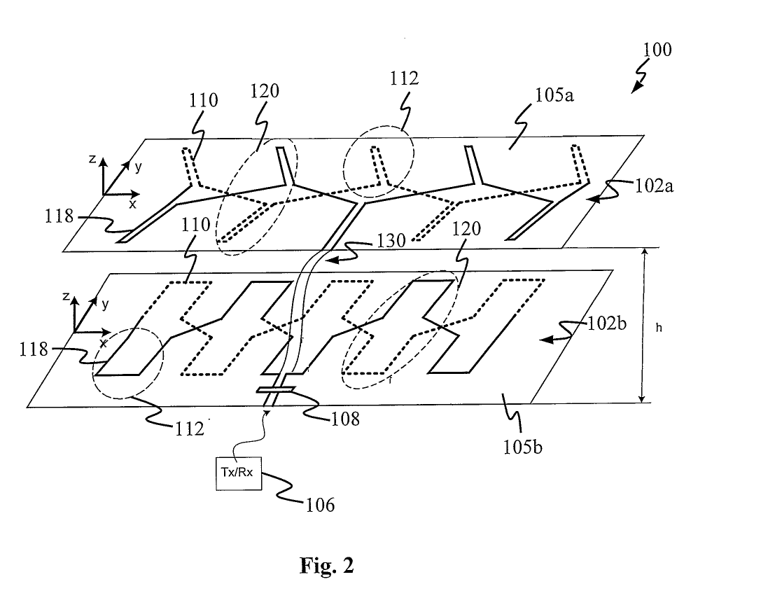

As shown in FIG. 2, the impedance matching network 108 is exemplarily connected to one of the loops 120 of the second radiating element 102b and to the corresponding overlapping loop 120 of the first radiating element 102a via the coupler 130. The impedance matching network 108 is connectable to any part of the radiating element 102b and is dependent on design or system requirements.

The arrangement of the loops 120 of the first and second radiating elements 102a, 102b causes the flow of an electrical current i in any loop 120 of the first radiating element 102a to be in rotationally similar direction as the corresponding loop 120 of the second radiating element 102b. The electrical currents i flowing in any two adjacent loops 120 of each of the first and second radiating elements 102a, 102b are in opposite rotational directions. In this way, the electrical currents i that flow in two corresponding loops 120 between the first and second radiating elements 102a, 102b are consequently in phase while the electrical currents i that flow in two adjacent loops 120 of each of the first and second radiating elements 102a, 102b are in phase opposition.

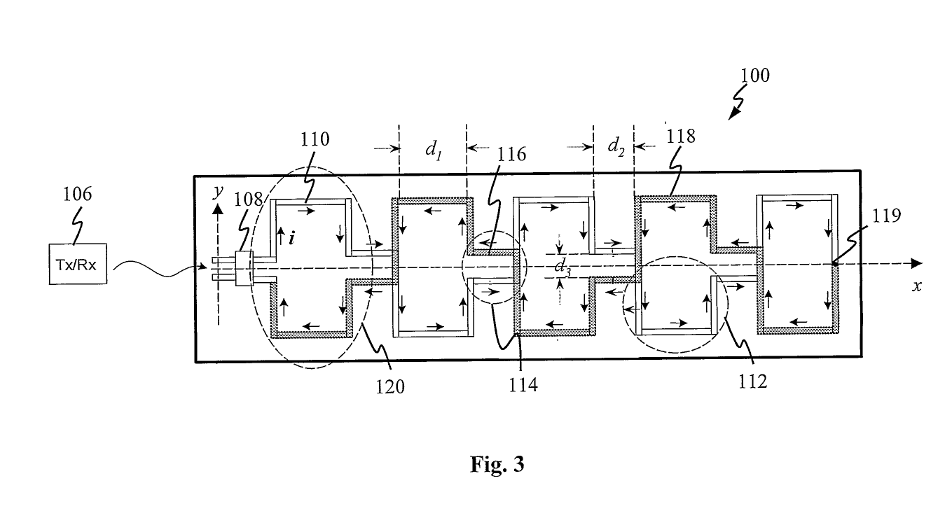

FIG. 3 shows one of the radiating elements 102a, 102b during operation, when an electrical current i flows therethrough via the feed 106. The configuration of the loops 120 causes the flow of the electrical current i in any loop 120 to be in one rotational direction and any two adjacent loops 120 to be in opposite rotational directions and thereby causes alternating magnetic flux to be formed along the x-axis. In this way, the electrical currents i that flow in the two adjacent loops 120 are consequently in phase opposition.

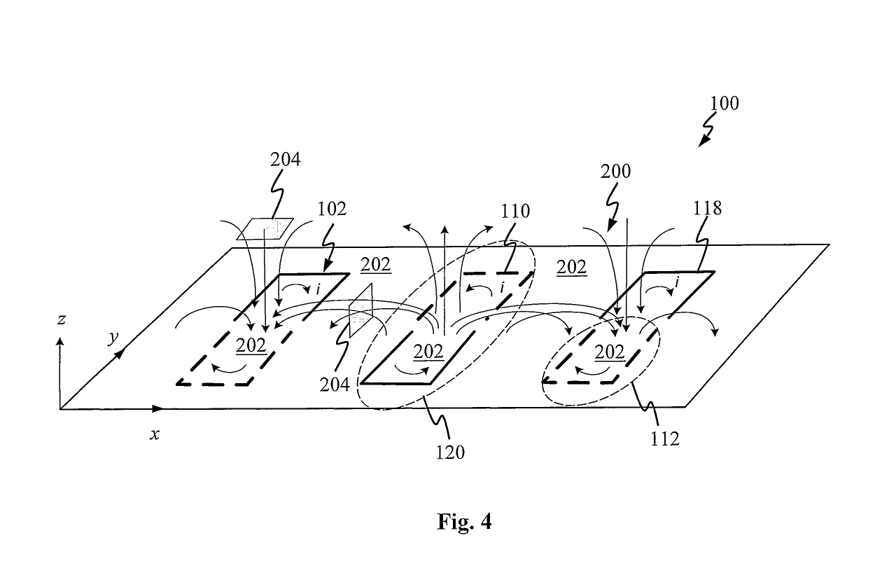

The electrical current i energizes the loops 120 and thereby produces a magnetic field 200, as illustrated in FIG. 4, that interacts to create an interrogation region 202. The interrogation region 202 is defined by a space immediately surrounding each loop 120 and between two adjacent loops 120 spaced apart by the junction 114 or connectors 116, as well as the volume above and below the antenna 100.

The magnetic field 200 energizes and powers up RFID tags 204 that are provided within the interrogation region 202. The RFID tags 204 subsequently generate RFID signals that contain tag data stored therein. The RFID signals are in turn received by the antenna 100 and transmitted to an RFID reader via the antenna 100.

The phase opposition of the electrical currents i that flow in two adjacent loops 120 advantageously produces the magnetic field 200 that is substantially uniform in amplitude throughout the interrogation region 202. This configuration of the radiating element 102 and the generation of the uniform magnetic field 200 within the interrogation region 202 desirably allow the RFID tags 204 to be read substantially independent of the orientation of the tags 204.

The strength of the magnetic field 200 is dependable on the magnitude of the electrical current i, the area of each loop 120 and the displacement between adjacent loops 120.

When the first and second radiating elements 102a, 102b are in operation, each of the first and second radiating elements 102a, 102b generates a magnetic field 200, as previously described and illustrated in FIG. 4. The magnetic field 200 generated by each of the first and second radiating elements 102a, 102b has null regions where within the magnetic field strength is at a minimal level.

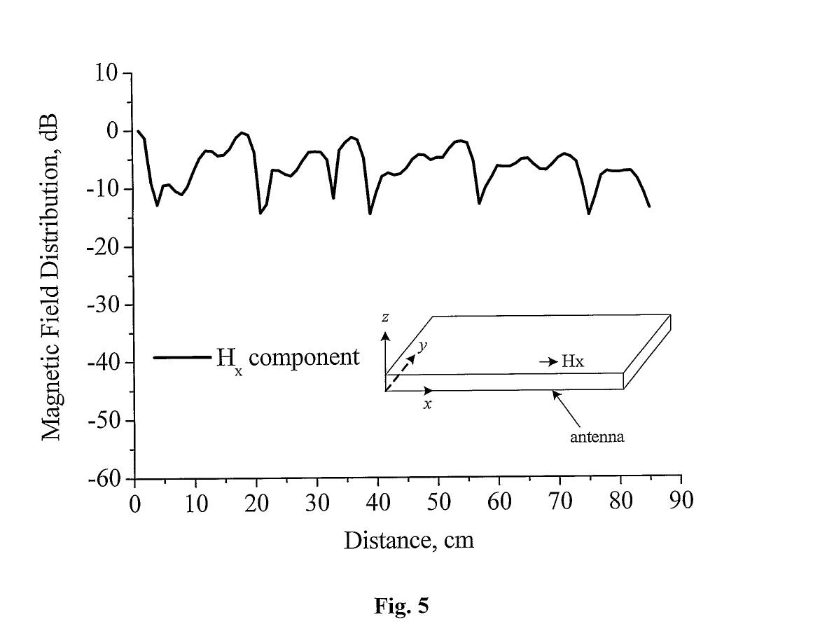

The magnetic field 200 generated by the first radiating element 102a interacts with the magnetic field 200 generated by the second radiating element 102b and produces a resultant magnetic field that has a magnetic field distribution as shown in the graph of FIG. 5. The resultant magnetic field is a superposition of the magnetic fields 200 generated by each of the first and second radiating elements 102a, 102b. More specifically, each null region of the magnetic field 200 generated by the first radiating elements 102a is compensated or superimposed with a non-null region of the magnetic field 200 generated by the second radiating elements 102b and vice versa.

The graph of FIG. 5 shows that the magnetic field distribution of the resultant magnetic field along the x-axis direction achieving a higher uniformity than the magnetic field distribution of the magnetic field 200 generated by each of the first and second radiating elements 102a, 102b along the same x-axis direction. The higher uniformity of the magnetic field distribution of the resultant magnetic field advantageously allows more reliable radio frequency identification within the interrogation region 200. The improved uniformity of the magnetic field distribution therefore desirably increases the reading rate of any RFID tags 204 found within the interrogation region 200.

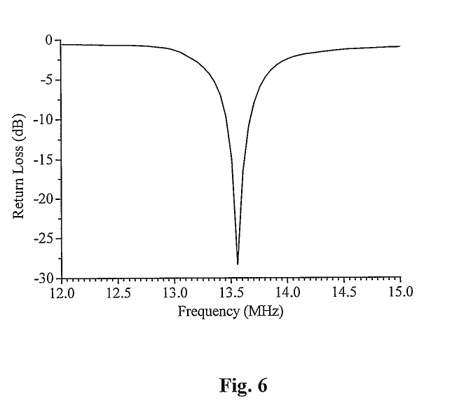

FIG. 6 is a graph that shows measured returned loss of the antenna 100 at 13.56 MHz. The measured result shows the antenna 100 having a well-matched impedance matching characteristic at the measured frequency of 13.56 MHz. This also suggests that the antenna 100 of FIG. 1 is advantageously capable of providing, for example, 50-ohm impedance matching through the use of the impedance matching network 108.

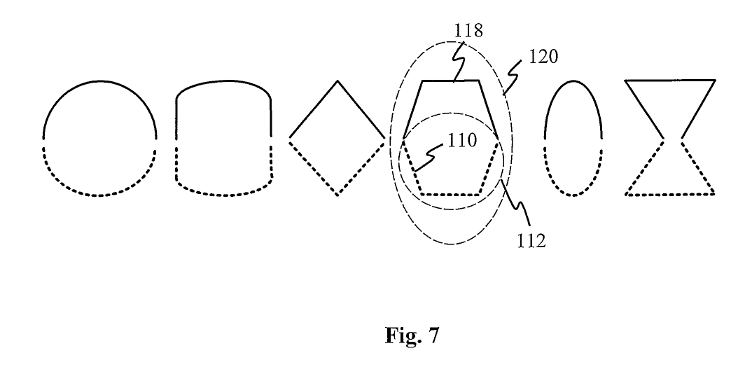

FIG. 7 shows exemplary geometrical shapes of the loop 120. The dimensions and geometrical shape of each loop 120 are dependent on design requirements. For example, the lobed portions 112 of FIG. 3 have a substantially rectangular shape such that an exemplary dimension of the width d₁ of each lobed portion 112 of the first and second shaped segments 110, 118 is preferably approximately 80 millimeters (mm). At the same time, the lateral displacement d₂ between two adjacent loops 120 is preferably approximately 65 mm while the spatial distance d₃ between ends of two opposing lobed portions 112 is preferably approximately 30 mm.

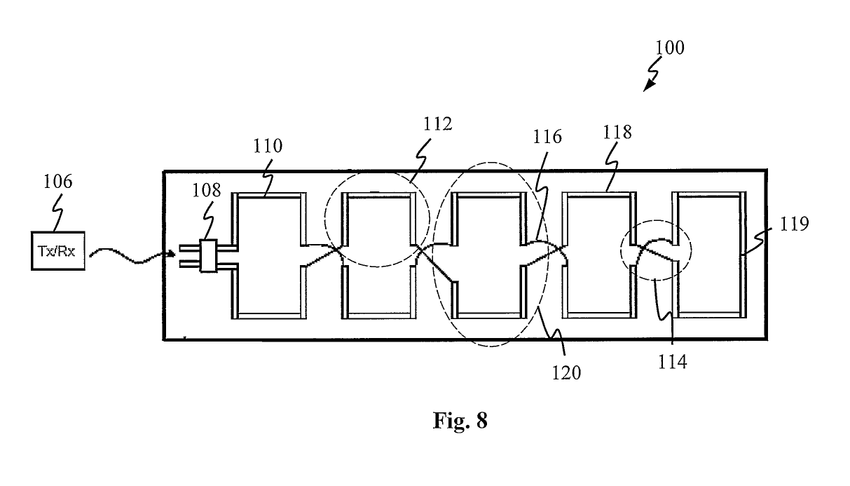

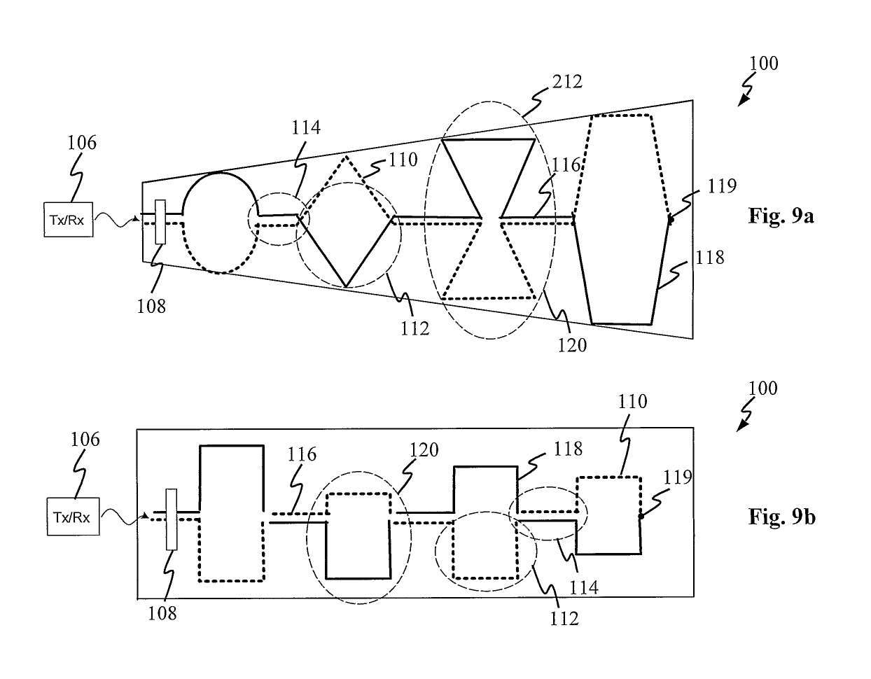

As shown in FIG. 8, the first and second shaped segments 110, 118 may also be coplanar and are formed on a same surface, such as on one of the opposite sides of the first substrate 105a or the second substrate 105b. Each connector 116 is preferably physically separated from an adjacent connector 116 by a dielectric layer, such as an air gap or bridge. The dielectric layer also preferably physically separates any overlapping portions between the first and second shaped segments 110, 118. The first and second shaped segments 110, 118 are connected at the connecting point 119. As shown in FIGS. 9a and 9b, the loop 120 of the antenna 100 may have different sizes and are arranged according to an increasing or decreasing order of the sizes. Additionally, the loop 120 may be constructed from conductive materials in other geometrical forms, such as ellipses, triangles, polygons or annuli.

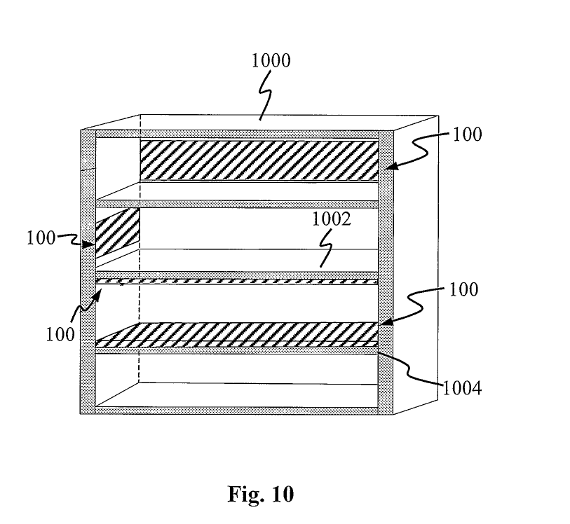

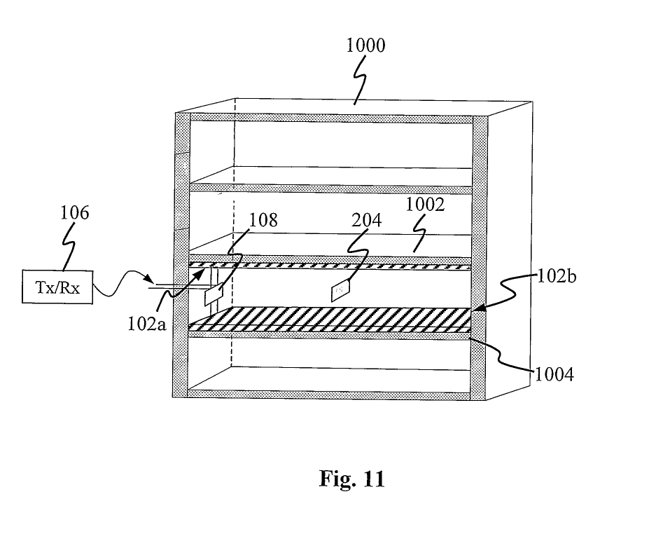

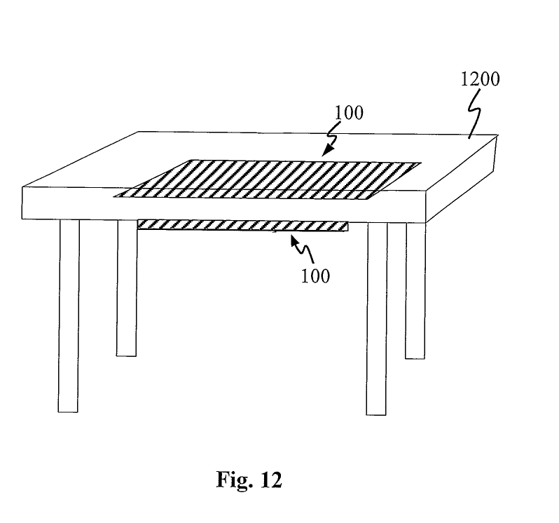

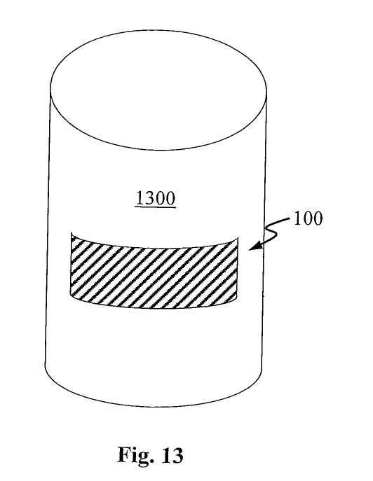

The drawings as shown in FIGS. 10 to 13 demonstrate exemplary implementations of the embodiments of the antenna 100 for reading RFID tags 204. The antenna 100 is shown in FIG. 10 to be attached to different locations of a shelf 1000, such as on or underneath a shelf rack 1002 and in between the shelf racks 1002. FIG. 11 shows the first radiating element 102a being attached to the underside of the shelf rack 1002 while the second radiating element 102b is attached to the top of another shelf rack 1004 immediately below the shelf rack 1002 such that the first and second radiating elements 102a, 102b are spaced apart by free space. An RFID tag 204 is identifiable within the free space. FIG. 12 shows the antenna 100 being embedded in or attached to an underside of a tabletop 1200. FIG. 13 shows the antenna 100 being attached to a curved surface 1300.

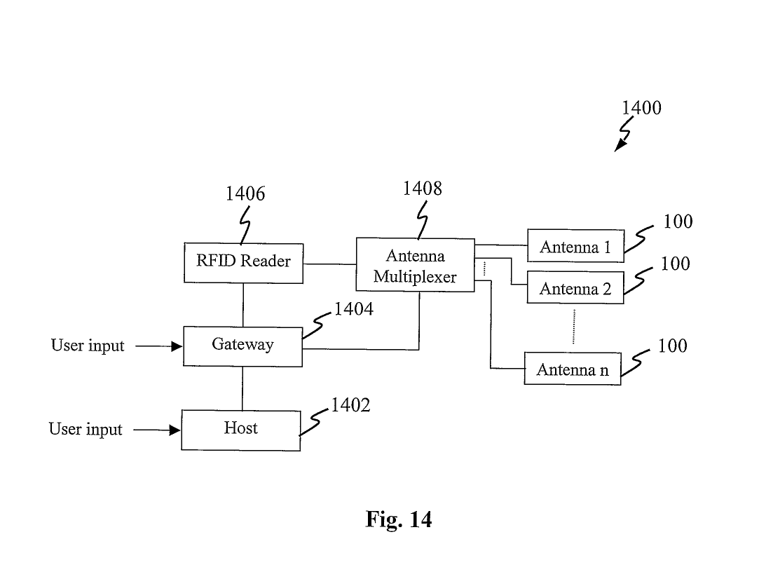

FIG. 14 shows a block diagram of a system 1400 according to another embodiment of the invention for RFID applications, such as reading and tracking of RFID tags. The system 1400 has a host 1402 that allows a user to send and receive data in relation to the tracking of the RFID tags. The RFID tags are typically attached to articles stored in a housing structure, such a shelf or cupboard. A gateway 1404 is coupled to the host 1402 for controlling the data sent by or to the host 1402, and an RFID reader 1406 is coupled to the gateway 1404 for reading RFID signals. The system 1400 preferably contains more than one antenna 100 for transmitting and receiving radio frequency signals and further contains an antenna multiplexer 1408 that is coupled to both the gateway 1404 and the RFID reader 1406 for switching and selecting when there is more than one antennas 100 for reading RFID signals.

The host 1402, for example a computer or mobile device like a laptop or a personal digital assistant (PDA), is preferably capable of performing wireless communication that supports specifications such as IEEE 802.11 in either ad hoc mode or infrastructure mode. The host 1402 is preferably capable of display information related to tracking of the RFID tags when requested by the user of the system 1400. The host 1402 preferably further provides routing capability for supporting multiple users of the system 1400.

The gateway 1404 is capable of performing either wireless or wired communication and preferably provides IEEE 802.11 wireless communication between the host 1402, the RFID reader 1406 and the antenna multiplexer 1408. The IEEE 802.11 wireless communication of the gateway 1404 is preferably performed in either ad hoc mode or infrastructure mode. The ad hoc mode is more cost effective and is suitable where wireless communication infrastructure is not available. The infrastructure mode is suitable where high bandwidth communication is required, especially for managing inventory flow.

The RFID reader 1406 preferably supports reading high frequency (HF) RFID signals at 13.56 megahertz (MHz) or at other high frequencies. The RFID reader 1406 provides powering up signals to the antenna 100 via the antenna multiplexer 1408. The powering up signals are transmitted to the RFID tags for energizing the RFID tags. Once the RFID tags are energized, RFID signals containing tag data stored in the RFID tags are subsequently transmitted therefrom. The tag data contain information pertaining to the RFID tags. The RFID signals are received by the antenna 100 and are then read by the RFID reader 1406. The RFID reader 1406 thereafter provides the RFID signals to the host 1402 via the gateway 1404 for displaying the tag data stored in the RFID tags.

The antenna multiplexer 1408 is preferably cascadable and has a plurality of output ports for optimizing and accommodating different multi-antenna configuration requirements. The antenna multiplexer 1408 further switches and selects antennas 100 for reading RFID tags as required by the user or users of the system 1400.

In the foregoing manner, an antenna for an RFID system for RFID applications is disclosed. Although only a number of embodiments of the invention are disclosed, it becomes apparent to one skilled in the art in view of this disclosure that numerous changes and/or modification can be made without departing from the scope and spirit of the invention. For example, the substrate may be formed in various shapes and sizes to satisfy specific design or system requirements.

1. An antenna for radio frequency identification, the antenna comprising:
a first radiating element having at least one loop element;
a second radiating element spatially displaced from the first radiating element and having at least two interconnected loop elements; and
a coupler for electrically coupling the first and second radiating elements,
wherein when a first current flows in the first radiating element for generating a first magnetic field and a second current flows in the second radiating element for generating a second magnetic field, one of the first and second magnetic fields superimposes the other of the first and second magnetic fields for generating an interrogation region in the near field of the first and second radiating elements.

2. The antenna of claim 1, wherein the second current flowing in one of the at least two interconnected loop elements of the second radiating element is in rotationally opposite direction to the other of the at least two interconnected loop elements of the second radiating element.

3. The antenna of claim 1, wherein the first current flowing in the at least one loop element of the first radiating element is in rotationally similar direction to one of the at least two interconnected loop elements of the second radiating element.

4. The antenna of claim 1, wherein the first magnetic field has at least one non-null region and the second magnetic field has at least one null region, the at least one non-null region of the first magnetic field being compensated with the at least one null region of the second magnetic field for providing a resultant magnetic field having substantially equal magnetic field strength within the interrogation region.

5. The antenna of claim 1, wherein each of the first and second radiating elements is substantially planar.

6. The antenna of claim 1, wherein each of the first and second radiating elements is formed on a substantially planar surface.

7. The antenna of claim 1, wherein the first radiating element is substantially parallel to the second radiating element.

8. The antenna of claim 1, wherein the first and second radiating elements are formed on opposite sides of a substrate.

9. The antenna of claim 1, wherein the first radiating element is substantially laterally displaced with respect to the second radiating element by a predetermined displacement.

10. The antenna of claim 1, wherein the at least one loop element of the first radiating element substantially overlaps with one of the at least two interconnected loop elements of the second radiating element.

11. The antenna of claim 1, wherein the coupler further couples to an impedance matching network for matching the impedance of the first and second radiating elements and a feed.

12. The antenna of claim 1, wherein the coupler comprises at least two connecting wires for interconnecting the first and second radiating elements.

13. The antenna of claim 12, wherein the at least two connecting wires connect the at least one loop element of the first radiating element to one of the at least two interconnected loop elements of the second radiating element.

14. A method for configuring an antenna for radio frequency identification, the method comprising the steps of:
providing a first radiating element having at least one loop element;
providing a second radiating element spatially displaced from the first radiating element and having at least two interconnected loop elements,
providing a coupler for electrically coupling the first and second radiating elements; and
wherein when a first current flows in the first radiating element for generating a first magnetic field and a second current flows in the second radiating element for generating a second magnetic field, one of the first and second magnetic fields superimposes the other of the first and second magnetic fields for generating an interrogation region in the near field of the first and second radiating elements.

15. The method of claim 14, further comprising the step of flowing the second current in one of the at least two interconnected loop elements of the second radiating element in rotationally opposite direction to the other of the at least two interconnected loop elements of the second radiating element.

16. The method of claim 14, further comprising the step of flowing the first current in the at least one loop element of the first radiating element in rotationally similar direction to one of the at least two interconnected loop elements of the second radiating element.

17. The method of claim 14, further comprising the step of providing a resultant magnetic field having substantially equal magnetic field strength within the interrogation region.

18. The method of claim 14, wherein the step of providing a coupler for electrically coupling the first and second radiating elements comprises the step of providing at least two connecting wires for interconnecting the first and second radiating elements.

19. The method of claim 18, wherein the step of providing at least two connecting wires comprises the step of connecting the at least one loop element of the first radiating element to one of the at least two interconnected loop elements of the second radiating element.

20. The method of claim 14, wherein the step of providing a coupler for electrically coupling the first and second radiating elements further comprises the step of coupling the coupler to an impedance matching network for matching the impedance of the first and second radiating elements and a feed.

21. A system for radio frequency identification applications, the system comprising:
a host for sending and receiving data;
a gateway being coupled to the host for controlling the data sent to and from the host;
a radio frequency identification reader coupled to the gateway for reading radio frequency signals;
at least one antenna for transmitting and receiving radio frequency signals, each of the at least one antenna having a first radiating element and a second radiating element; and
an antenna multiplexer being coupled to the gateway and the radio frequency identification reader for selecting the at least one antenna for reading data,
wherein when a first current flows in the first radiating element for generating a first magnetic field and a second current flows in the second radiating element for generating a second magnetic field, one of the first and second magnetic fields superimposes the other of the first and second magnetic fields for generating an interrogation region in the near field of the first and second radiating elements.
